(19) United States
(12) Patent Application Publication
(10) Pub. No.: US 2026/0208172 A1
(43) Pub. Date: Jul. 23, 2026

(54) SYNTHESIS OF ZEOLITE USING HYDROUS KAOLIN

(71) Applicant: BASF CORPORATION, Florham Park, NJ (US)

(72) Inventors: Xingtao GAO, Holmdel, NJ (US); Christopher John GILBERT, South Brunswick, NJ (US); Qi FU, Moreland Hills, OH (US); Mukta RAI, Marlboro, NJ (US); Vijay KOBETIC, Rocky River, OH (US)

(73) Assignee: BASF CORPORATION, Florham Park, NJ (US)

(21) Appl. No.: 19/133,482

(22) PCT Filed: Dec. 14, 2023
(86) PCT No.: PCT/US2023/084026

§ 371 Date: May 28, 2025

Related U.S. Application Data
(60) Provisional application No. 63/432,441, filed on Dec. 14, 2022.
(60) Provisional application No. 63/539,648, filed on Sep. 21, 2023.

(51) Int. Cl. B01J 29/70; B01J 29/40; B01J 35/70; B01J 37/06; B01J 37/08; B01J 37/30

(52) U.S. Cl. CPC B01J 29/7015; B01J 29/40; B01J 35/70; B01J 37/06; B01J 37/08; B01J 37/30; B01J 2235/15

(57) ABSTRACT

Described herein is a process for preparing a zeolite including mixing an aluminum source, a sodium source and water to form a mixture. After mixing, a silicon source is added and mixed. Then, a zeolite crystal or zeolite seed is added to form a gel mixture, which is then crystallized at a temperature of about 100° C. to about 200° C. for about 10 to about 108 hours to obtain zeolite crystals.

### CROSS REFERENCE TO RELATED APPLICATION(S)

The present application claims priority to U.S. Provisional Patent No. 63/432,441 filed on Dec. 14, 2022 and U.S. Provisional Patent No. 63/539,648 filed on Sep. 21, 2023, the entire contents of which are incorporated herein in their entirety.

### FIELD OF THE INVENTION

The present invention relates generally to a process for preparing a zeolite. Specifically, the process includes preparing the zeolite using a crystallization process. The zeolite may be used in the preparation of FCC catalytic material. In another embodiment, the zeolite may be part of an exhaust gas treatment system used to treat exhaust gas streams, in particular those emanating from gasoline or diesel engines.

### BACKGROUND OF THE INVENTION

Refinery products of gasoline, light olefins and light cycle oil are always more valuable than bottoms fractions. Catalyst compositions that can selectively produce one of the valuable fractions are desirable for refiners. Currently, phosphorous containing ZSM-5 additives can selectively crack gasoline range olefins in FCC units to generate light olefins of ethylene, propylene and butylene. Therefore, ZSM-5 containing catalysts have been widely used by refineries to obtain light olefins in FCC petrochemical process.

Metal-promoted zeolites, such as copper exchanged zeolites, are used to promote the reaction of ammonia (or an ammonia precursor, such as urea) with nitrogen oxides (NO_{X}) in the presence of oxygen to form nitrogen and H₂O, selectively over the competing reaction of oxygen. The catalyzed reaction is therefore generally referred to as selective catalytic reduction (SCR), in which a high degree of nitrogen oxide removal can be achieved using a small amount of a reducing agent. In some embodiments, chabazite (CHA) may be used as a catalyst in such reaction.

In a typical zeolite manufacturing process, zeolites are crystallized using a solution that is typically less than 25 wt % solids. These reactions are most often run in a slurry form with a significant amount of water present. However, the amount of water can reduce production amounts and can be more expensive to run. Thus, there is a need to improve the current crystallization processes.

### SUMMARY OF THE INVENTION

It has been found that utilizing hydrous kaolin as the aluminum source to synthesize a zeolite, for example, ZSM-5, can achieve high gel solids of about 25 wt % or more, which results in high zeolite productivity. It was also found that utilizing hydrous kaolin as the sole aluminum source to synthesize a zeolite with a lower solid content, for example, chabazite, can provide a process with high manufacturing efficiency and cost competitiveness. Hydrous kaolin was found to significantly reduce the viscosity of gel mixture even when the solid content was high, such as 35 wt %, to allow sufficient mixing and reaction of the reagents during crystallization. Further, utilizing hydrous kaolin is advantageous because of its low cost and high product throughput rending the synthesis process to have high manufacturing efficiency and cost competitiveness.

In an embodiment of the present invention, a process for preparing a zeolite is provided. The process includes mixing an aluminum source, a sodium source or a potassium source, and water to form a first mixture. The process further includes adding a silicon source to the first mixture and mixing, then adding a zeolite crystal or a zeolite seed to form a gel mixture. The process further includes crystallizing the gel mixture at a temperature from about 150° C. to about 200° C. for about 12 to about 48 hours to obtain zeolite crystals. In some embodiments of the process, the aluminum source is hydrous kaolin.

The process of the present disclosure will be described with reference to using ZSM-5 as a zeolite, unless otherwise stated, but should be understood that it can be applied to various zeolitic materials, including but not limited to aluminosilicate zeolites, aluminum phosphate zeolites, gallium phosphate zeolites, silicon aluminum phosphate zeolites, metal aluminum phosphate zeolites (where metal represents a transition metal element), germanosilicate zeolites, borosilicate zeolites, beryllosilicate zeolites, zincosilicate zeolites, and titanosilicate zeolite. In another embodiment, the process of the present disclosure may be described with reference to using chabazite as a zeolite where stated.

In some embodiments of the process, the sodium source may be sodium silicate. In some embodiments of the process, the potassium source may be potassium silicate. In some embodiments of the process, the silicon source may include an aqueous dispersion of colloidal silica as a solid at or above about 20 wt %. In some embodiments, the silicon source may include, but are not limited to, sodium silicate, sodium meta-silicate, potassium silicate, stabilized silica sols, silica gels, polysilicic acid, tetra ethylortho silicate, fumed silicas, precipitated silicas, or mixtures thereof.

The aluminum source and/or silicon source may be doped with a suitable dopant. In some embodiments, the dopant may include compounds including rare earth metals such as Ce, La, Y, Gd, Eu, Pr, Sm, Ho, Nd, Er, Yb, or Tb; alkaline and alkaline earth metals such as Mg, Ca, K, Na, and Ba, transition metals such as Zr, Mn, Fe, Ti, Ag, Au, Cu, Ni, Zn, Mo, W, V, and Sn, actinides, noble metals such as Rh, Ru, Pt and Pd, group III, IV, or V elements such as Ga, B, In, Ge and/or P.

A base may be added to the gel mixture to adjust the pH, wherein the base may include sodium hydroxide, potassium hydroxide, lithium hydroxide, cesium hydroxide, ammonium hydroxide, magnesium hydroxide, or calcium hydroxide.

In some embodiments, the hydrous kaolin may have a particle size with D90 (diameter of 90 percentage of particles) below 30 μm, below 20 μm, or below 15 μm.

In some embodiments of the process, the zeolite crystal may be ZSM-5.

In some embodiments of the process, the hydrous kaolin may have a solid content of about 50 wt % to about 75 wt % solids.

In some embodiments of the process, the zeolite crystal or the zeolite seed may have a silica to alumina ratio (SAR) of about 20 to about 35.

In some embodiments, the process may further include post-treating the zeolite crystals with an acid wash or ion exchange to remove sodium or potassium. In some embodiments, the acid wash may include using diluted sulfuric acid having a concentration of about 1% to about 20%. In some embodiments, the ion exchange may include using ammonium nitrate or sulfate solution.

In some embodiments of the process, the sodium may be removed such that the amount of sodium oxide in the zeolite crystals is less than about 0.4 wt %, or less than about 0.2 wt %.

In some embodiments, the zeolite crystals as crystallized in sodium form may have a XRD crystallinity of greater than about 85% and TSA greater than about 260 m2/g.

In some embodiments of the process, the gel mixture may have a SiO₂/Al₂O₃ molar ratio of about 30 to about 42. In some embodiments, the gel mixture may have a Na₂O/SiO₂ and OH/Si molar ratio of about 0.1 to about 0.3. In some embodiments, the gel mixture has a H₂O/SiO₂ molar ratio of less than about 11.

In some embodiments of the process, the zeolite crystal or the zeolite seed may be included in an amount of about 0.1 wt % to about 6 wt %.

In some embodiments of the process, the gel mixture may have a solid content of at least about 25%.

In some embodiments of the process, the crystallization may be achieved by heating the gel mixture in an autoclave. In some embodiments, the gel mixture after crystallization may be separated to obtain zeolite crystals.

In some embodiments of the process, the mixing order of raw materials may be changed depending on mixing efficiency.

In some embodiments of the process, the zeolite crystal may have a particle size with D90 below 25 μm, or below 15 μm.

In some embodiments of the process, the zeolite seed may be a FCC or FAU seed.

In another embodiment of the present disclosure, a zeolite crystal is provided. The zeolite crystal includes ZSM-5 having a SAR from about 24 to about 40 and a sodium content of less than about 0.4%.

In yet another embodiment, a process of preparing a chabazite (CHA) zeolite is provided. The process includes preparing an aqueous mixture including a silica source, a sole alumina source, a base agent and an organic structure directing agent (OSDA) to form a gel mixture. The process further includes crystallizing the gel mixture at a temperature from about 100° C. to about 200° C. for about 10 to about 108 hours to obtain zeolite crystals. In some embodiments, the sole aluminum source may be hydrous kaolin.

In some embodiments, the process may further include a sodium source. The sodium source may be sodium silicate or potassium silicate. In some embodiments, the silicon source may be a colloidal silica, or fume silica, wherein the colloidal silica may be an aqueous colloidal silica with a solid content at or above 20 wt. %.

In some embodiments, the hydrous kaolin may have a particle size with D90 (diameter of 90 percentage of particles) below 30 μm, below 25 μm, below 15 μm, or below 12 μm.

In some embodiments, the base agent may be an alkali metal hydroxide. In some embodiments, the alkali metal hydroxide may be sodium hydroxide.

In some embodiments, the hydrous kaolin may have a solid content of about 50 wt % to about 75 wt % solids. In some embodiments, the hydrous kaolin may have a solid of at least about 50 wt % solids.

In some embodiments, the process may further include post-treating the zeolite crystals with an acid wash or ion exchange to remove sodium. In some embodiments, the acid wash may include using diluted sulfuric acid may have a concentration of about 1% to about 20%. In some embodiments, the ion exchange may include using ammonium nitrate or sulfate solution. In some embodiments, the sodium may be removed such that the amount of sodium oxide in the zeolite crystals may be less than about 0.2 wt %, or less than about 0.02 wt %.

In some embodiments, the OSDA agent may include a quaternary ammonium salt. In some embodiments, the quaternary ammonium salt may include trimethyl adamantyl ammonium hydroxide, trimethyl benzyl ammonium hydroxide, triethyl cyclohexyl ammonium hydroxide, or combinations thereof. In certain embodiments, the quaternary ammonium salt may include trimethyl adamantyl ammonium hydroxide. In certain embodiments, the quaternary ammonium salt may include trimethyl benzyl ammonium hydroxide. In certain embodiments, the quaternary ammonium salt may include triethyl cyclohexyl ammonium hydroxide.

In some embodiments, the base agent may include NaOH, KOH, F, quaternary ammonium hydroxide, diquaternary ammonium hydroxide, or combinations thereof. In certain embodiments, the base agent may be NaOH. In certain embodiments, the base agent may be KOH. In certain embodiments, the base agent may be F—. In certain embodiments, the base agent may be quaternary ammonium hydroxide. In certain embodiments, the base agent may be diquaternary ammonium hydroxide.

In some embodiments, the gel mixture may have a solid content of at least about 15%. In some embodiments, the crystallization may be achieved by heating the gel mixture in an autoclave. In some embodiments, the gel mixture after crystallization may be separated to obtain zeolite crystals.

In another embodiment, a method of producing a catalytic article is provided. The method includes coating a substrate with a catalytic coating using a washcoat process. The method further includes drying and calcining the coated substrate at a temperature of about 550° C. for about 1 hour. In some embodiments, the catalytic coating may include a chabazite, about 3.0 wt % to about 6.0 wt % copper oxide, about 5 wt % zirconium oxide, and about 5 wt % pseudoboehmite (PB-250) binder.

In some embodiments, a catalytic article may be produced. The catalytic article may include an ion-exchanged chabazite, wherein the chabazite may have a zeolite surface area (ZSA) of greater than about 450 m²/g.

In some embodiments, a method of reducing nitrogen oxides (NO^{X}) may include contacting a gaseous stream comprising nitrogen oxides with at least one ion exchanged chabazite or at least one catalytic article.

### DETAILED DESCRIPTION OF THE INVENTION

The present invention advances the state of the art by developing a process for preparing a zeolite using hydrous kaolin as the aluminum source with a higher solid content, such as above 20 wt %. In some embodiments, the state of the art is advanced through a process for preparing a zeolite using hydrous kaolin as the sole aluminum source. The hydrous kaolin used herein is raw material without further thermal or chemical treatment before being used in the process herein. Thus, the hydrous kaolin used in the process of the present invention is the lowest cost aluminum source for synthesis of zeolite, such as ZSM-5. In other embodiments, the zeolite may be chabazite, beta, ZSM-11, ZSM-23, or SAPO. Hydrous kaolin is in the form of a fine powder or aqueous slurry having a solids content of about 50 wt % or above, or about 60 wt % or above, or about 70 wt % or above. The particle size of the hydrous kaolin in fine powder form or slurry form is low at D90 (diameter of 90 percentage of particles) below 30 μm, below 20 μm, below 15 μm, or below 12 μm.

In addition to an aluminum source to form a zeolite, a silica source, or a silica/sodium source is also used. In some embodiments, the silica source may be a sodium silicate. The sodium silicate may be selected from N-brand, or silica gel. In other embodiments, the silica source may be colloidal silica or fume silica, such as Ludox AS-40. In some embodiments, the colloidal silica is an aqueous colloidal silica with a solid at or above 20 wt. %. In some embodiments of the process, a zeolite crystal or a zeolite seed may be used as seeds to improve the product quality. The zeolite crystal particle, such as ZSM-5 particles may have a particle size of D90 less than about 25 μm, less than about 15 μm, or less than about 12 μm to achieve better product quality.

The inventors have found that using hydrous kaolin as the aluminum source, then the preparation of the zeolite can achieve high gel solids of at least about 15 wt %, or at least about 25 wt % or more, which results in high zeolite productivity (STY-space time yield). In contrast, current zeolites, such as ZSM-5, using other aluminum sources, such as aluminum sol, sodium aluminate, aluminum sulfate, or other organic alumina salt such as aluminum isopropoxide, needs to have a solid content of less than about 20 wt %, or about 5 to about 15 wt % because these aluminum sources were found to cause extremely high viscosity of the gel mixture at higher solids or can solidify in the gel mixture. By using hydrous kaolin as the aluminum source, it significantly reduces the viscosity of the gel mixture, even when the solids content is higher, such as 35 wt %, to allow the sufficient mixing and reaction of the reagents during crystallization.

It was also found that a zeolite made with hydrous kaolin as the sole aluminum source has similar or better catalytical performance than zeolite made with other aluminum sources. Moreover, zeolite made with other coarse kaolin either has lower crystallinity and/or inferior catalytical performance. Hydrous kaolin as well as high product throughput renders the process to have high manufacturing efficiency and be cost competitive.

The inventors also have found that after calcining the hydrous kaolin at high temperature to convert to metakaolin phase, the fine metakaolin particles can also be used as the aluminum source to achieve high gel solids of about 25 wt % or more for ZSM-5 crystallization process. However, because of the extra cost associated with calcination renders the hydrous kaolin the best option for current high solids zeolite crystallization processes, such as ZSM-5, or for other crystallization processes of other zeolites, such as chabazite.

Various embodiments are described hereinafter. It should be noted that the specific embodiments are not intended as an exhaustive description or as a limitation to the broader aspects discussed herein. One aspect described in conjunction with a particular embodiment is not necessarily limited to that embodiment and can be practiced with any other embodiment(s).

As used herein, “about” will be understood by persons of ordinary skill in the art and will vary to some extent depending upon the context in which it is used. If there are uses of the term which are not clear to persons of ordinary skill in the art, given the context in which it is used, “about” will mean up to plus or minus 10% of the particular term.

The articles “a”, “an”, and “the” are used herein to refer to one or to more than one (i.e., to at least one) of the grammatical object of the article. By way of an example, “a seed” means one seed or more than one seed.

All references to wt % or wt. % throughout the specifications and the claims refer to the weight of the component in reference to the weight of the entire composition.

Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context.

The use of any and all examples, or exemplary language (e.g., “such as”) provided herein, is intended merely to illuminate certain materials and methods and does not pose a limitation on scope. No language in the specification should be construed as indicating any non-claimed element as essential to the practice of the disclosed materials and methods.

As used herein, the term “organic structure directing agent” (OSDA) refers to an organic compound capable of affecting the morphology and/or structure of a zeolite. For example, an OSDA may be an ionic organic molecule capable of being incorporated into the zeolite's structure. An OSDA may for example, include a large and/or sterically bulky organic group. An OSDA may, for example, include an adamantammonium group. In an embodiment, trimethyl adamantammonium may be, but is not limited to, an OSDA in the present disclosure.

The present inventors have developed a process for preparing a zeolite using an aluminum and sodium source. In some embodiments, the process for preparing a zeolite may use a sole aluminum source and a sodium source. In one embodiment of the present invention, a process for preparing a zeolite is provided. The process for preparing the zeolite includes mixing an aluminum source, a sodium source and water to form a first mixture. In other embodiments, the process for preparing the zeolite includes mixing a sole aluminum source, a sodium source and water to form a first mixture. The process includes further adding a silicon source to the first mixture and mixing. In another embodiment, the process may include mixing an aluminum source, or a sole aluminum source and at least one of a sodium source, water and a silicon source. The process also includes adding a zeolite crystal or a zeolite seed to form a gel mixture. The process then includes crystallizing the gel mixture at a temperature from about 150° C. to about 200° C. for about 12 to about 48 hours to obtain prepared zeolite crystals. In another embodiment, the process may include crystallizing the gel mixture at a temperature from about 100° C. to about 200° C. for about 10 to about 108 hours. The aluminum source, or sole aluminum source may be hydrous kaolin.

In an embodiment, a process was developed for preparing a high solid zeolite (i.e. having at least 20 wt. % solid content), such as ZSM-5, using an aluminum and sodium source. The process includes mixing an aluminum source, a sodium source and water to form a first mixture. The process further includes adding a silicon source to the first mixture and mixing. The process also includes adding a zeolite crystal or a zeolite seed to form a gel mixture. The process then includes crystallizing the gel mixture at a temperature from about 150° C. to about 200° C. for about 12 to about 48 hours to obtain prepared zeolite crystals. The aluminum source may be hydrous kaolin, and the zeolite prepared may be ZSM-5.

In another embodiment, a process was developed for preparing a chabazite (CHA) zeolite. The process includes preparing an aqueous mixture including a sole alumina source, a silica source, a base agent, and an organic structure directing agent (OSDA) to form a gel mixture. The process further includes crystallizing the gel mixture at a temperature from about 100° C. to about 200° C. for about 10 to about 108 hours to obtain prepared zeolite crystals. The sole aluminum source may be hydrous kaolin.

In some embodiments, the crystallization of the gel mixture may be performed at a temperature from about 100° C., about 105° C., about 110° C., about 115° C., about 120° C., about 125° C., about 130° C., about 135° C., about 140° C., about 145° C., about 150° C., about 155° C., about 160° C., about 165° C., about 170° C., about 175° C., about 180° C., about 185° C., about 190° C., about 195° C., or about 200° C. In other embodiments, the crystallization may be performed at a temperature from about 100° C. to about 200° C., about 105° C. to about 195° C., about 110° C. to about 190° C., about 115° C. to about 185° C., about 120° C. to about 180° C., about 125° C. to about 175° C., about 130° C. to about 170° C., about 135° C. to about 165° C., about 140° C. to about 160° C., or about 145° C. to about 155° C. In yet another embodiment, the crystallization may be performed at a temperature of at least about 100° C., at least about 110° C., at least about 120° C., at least about 130° C., at least about 140° C., or at least about 150° C.

In some embodiments, the crystallization of the gel mixture may be performed for about 12 hours, about 14 hours, about 16 hours, about 18 hours, about 20 hours, about 22 hours, about 24 hours, about 26 hours, about 28 hours, about 30 hours, about 32 hours, about 34 hours, about 36 hours, about 38 hours, about 40 hours, about 42 hours, about 44 hours, about 46 hours, about 48 hours, about 54 hours, about 60 hours, about 66 hours, about 72 hours, about 78 hours, about 84 hours, about 90 hours, about 96 hours, about 102 hours, about 108 hours, about 114 hours, or about 120 hours. In some embodiments, the crystallization may be performed for about 10 hours to about 48 hours, about 10 hours to about 120 hours, about 12 hours to about 46 hours, about 14 hours to about 44 hours, about 16 hours to about 42 hours, about 18 hours to about 40 hours, about 18 hours to about 108 hours, about 20 hours to about 38 hours, about 22 hours to about 36 hours, about 24 hours to about 34 hours, about 24 hours to about 100 hours, about 26 hours to about 32 hours, about 28 hours to about 30 hours, about 30 hours to about 94 hours, about 36 hours to about 88 hours, about 42 hours to about 82 hours, about 48 hours to about 76 hours, about 50 hours to about 72 hours, about 52 hours to about 68 hours, or about 54 hours to about 60 hours. The temperature and time of crystallization may be chosen to limit the formation of impurities depending on the zeolite being synthesized.

In some embodiments, the hydrous kaolin may have a particle size D90 (diameter of 90 percent of particles) below 30 μm, below 25 μm, below 20 μm, below 15 μm, or below 12 μm. If the particle size is greater than about 30 μm, then the chemistry of the process will be affected and the amount of impurities will increase. If the particle size is too large, then the hydrous kaolin may not be a slurry because the particles cannot suspend in liquid. As hydrous kaolin is a fine particle slurry, it has been found to be the preferable aluminum source, or sole aluminum source as it is easy to control the particle size of the hydrous kaolin to be effective in the process of the present application. Additionally, hydrous kaolin is a well dispersed clay having a smaller particle size.

In some embodiments, the hydrous kaolin slurry may have a solid content of about 50 wt. % to about 75 wt. % solids. In other embodiments, the hydrous kaolin may have a solid content of about 55 wt. % to about 72 wt. %, about 60 wt. % to about 72 wt. %, or about 65 wt. % to about 71 wt. %. In other embodiments, the hydrous kaolin slurry may have a solid content of at least about 50 wt. %, at least about 55 wt. %, at least about 60 wt. %, at least about 65 wt. %, at least about 70 wt. %, or about 75 wt %.

In some embodiments, the sodium source may be sodium silicate, potassium silicate, or a combination thereof. In some embodiments, the silicon source may include a colloidal silica, fume silica, or a combination thereof. In some embodiments, the colloidal silica may be an aqueous dispersion of colloidal silica as a solid at or above 20 wt. %. In some embodiments, the colloidal silica may be included in the aqueous dispersion in an amount of at least about 20 wt. %, at least about 25 wt. %, at least about 30 wt. %, or at least about 35 wt. %.

The aluminum source and/or silicon source may be doped with a suitable dopant. In some embodiments, the dopant may include compounds including rare earth metals such as Ce, La, Y, Gd, Eu, Pr, Sm, Ho, Nd, Er, Yb, or Tb; alkaline and alkaline earth metals such as Mg, Ca, K, Na, and Ba, transition metals such as Zr, Mn, Fe, Ti, Ag, Au, Cu, Ni, Zn, Mo, W, V, and Sn, actinides, noble metals such as Rh, Ru, Pt and Pd, group III, IV, or V elements such as Ga, B, In, Ge and/or P.

In other embodiments, the zeolite crystal may be Zeolite Y, including HY, USY, dealuminated Y, RE-Y and RE-USY, ZSM-5, ZSM-11, IM-5, MCM-68, ZSM-57, ZSM-23, CIT-5, ZSM-35, MCM-22, MCM-56, MCM-49, UZM-8, EMM-10, ITQ-2, ITQ-30, TNU-9, ZSM-22, ZSM-18, EMM-26, Zeolite T, EMC-2, Offretite, Beta, ITQ-13, Zeolite A, Zeolite L, MCM-35, mordenite, ZSM-12, NU-87, ECR-1, EU-1, ZSM-50, Li-A, Na-P1, Na-P2, Chabazite, SSZ-13, SAPO-34, zeolite RHO, SSZ-35, SAPO-5, ITQ-12, Stilbite, CIT-7, ITQ-39, Linde Q, UZM-4, Natrolite, IPC-4, ZSM-48, SSZ-61, ITQ-4, ITQ-51, Mazzite, ZSM-4, SUZ-4, SSZ-48, SSZ-23, SAPO-11, SAPO-31 AIPO-18, SAPO-18, SAPO-41, ITQ-7, ITQ-3, SSZ-36, MCM-58. In some embodiments, the zeolite crystal may be ZSM-5 or chabazite.

In some embodiments, the ZSM-5 may have a particle size D90 of below about 25 μm, below about 20 μm, or below about 15 μm, or below about 12 μm. In some embodiments, the chabazite may have a particle size D90 of below about 25 μm, below about 20 μm, below about 15 μm, or below about 12 μm. In some embodiments, the zeolite crystals may have a silica to alumina ratio (SAR) of about 20 to about 40. In other embodiments, the zeolite crystals may have a SAR of about 20, about 24, about 28, about 30, about 32, about 34, or about 40.

In some embodiments the process may further include treating the zeolite crystals with an organic structure directing agent and/or a base agent to adjust the pH of the gel. The organic structure directing agent may include a base agent, such as an alkali metal hydroxide, caustic soda (NaOH), caustic potash (KOH) sodium hydroxide, or an acid, such as sulfuric acid. In another embodiment, the OSDA may be trimethyl adamantammonium. In some embodiments, the OSDA may include a quaternary ammonium salt. In some embodiments, the quaternary ammonium salt may include trimethyl adamantyl ammonium hydroxide, trimethyl benzyl ammonium hydroxide, triethyl cyclohexyl ammonium hydroxide, or combinations thereof. In certain embodiments, the quaternary ammonium salt may include trimethyl adamantyl ammonium hydroxide. In certain embodiments, the quaternary ammonium salt may include trimethyl benzyl ammonium hydroxide. In certain embodiments, the quaternary ammonium salt may include triethyl cyclohexyl ammonium hydroxide.

In some embodiments, the base agent may further include NaOH, KOH, F—, quaternary ammonium hydroxide, diquaternary ammonium hydroxide, or combinations thereof. In certain embodiments, the base agent may be NaOH. In some embodiments, the base agent may be KOH. In some embodiments, the base agent may be F—. In some embodiments, the base agent may be quaternary ammonium hydroxide. In some embodiments, the base agent may be diquaternary ammonium hydroxide.

In some embodiments, the process may further include post-treating the zeolite crystals with an acid wash or ion exchange to remove sodium and/or to adjust the pH of the gel. In some embodiments, the acid wash may include using diluted sulfuric acid having a concentration of about 1% to about 20%. In some embodiments, the diluted sulfuric acid may have a concentration of about 1%, about 2%, about 3%, about 4%, about 5%, about 6%, about 7%, about 8%, about 9%, about 10%, about 11%, about 12%, about 13%, about 14%, about 15%, about 16%, about 17%, about 18%, about 19%, or about 20%. In some embodiments, the ion exchange may include using an ammonium nitrate, or ammonium sulfate solution.

In some embodiments, sodium may be removed. In some embodiments of the process, the amount of sodium oxide in the zeolite crystal may be less than about 1 wt. %, less than about 0.9 wt. %, less than about 0.8 wt. %, less than about 0.7 wt. %, less than about 0.6 wt. %, less than about 0.5 wt. %, less than about 0.4 wt. %, less than about 0.3 wt. %, less than about 0.2 wt. %, or less than about 0.1 wt. %. In certain embodiments, the amount of sodium oxide in the zeolite crystal may be less than about 0.4 wt. %, or less than about 0.2 wt. %.

In some embodiments, the zeolite crystal may have a XRD crystallinity of greater than about 85% and total surface area (TSA) measured by Brunauer-Emmett-Teller (BET) surface area analysis greater than about 260 m²/g. In some embodiments, the zeolite crystal may have a XRD crystallinity of greater than about 85%, greater than about 88%, greater than about 90%, greater than about 92%, or greater than about 95%. In some embodiments, the zeolite crystal as crystallized in sodium-form may have a TSA greater than about 260 m²/g, about 265 m²/g, about 270 m2/g, about 275 m²/g, about 280 m²/g, about 285 m²/g, or about 290 m²/g. For example, the zeolite crystal may be ZSM-5 and have a XRD crystallinity of greater than about 85% and TSA of greater than about 260 m²/g. In some embodiments, the zeolite crystal as crystallized in sodium-form may have a TSA greater than about 550 m2/g, about 560 m²/g, about 570 m²/g, about 575 m²/g, about 580 m²/g. For example, the zeolite crystal may be chabazite and have a XRD crystallinity of greater than about 85% and TSA of greater than about 550 m²/g.

In some embodiments of the process, the gel mixture may have a SiO₂/Al₂O₃ molar ratio of about 30 to about 45. In certain embodiments, the gel mixture may have a SiO₂/Al₂O₃ molar ratio of about 30, about 32, about 34, about 36, about 38, about 40, about 42, or about 45.

In some embodiments of the process, the gel mixture may have a Na₂O/SiO₂ and OH/Si molar ratio of about 0.1 to about 1. In certain embodiments, the gel mixture may have a Na₂O/SiO₂ and OH—/Si molar ratio of about 0.1, about 0.2, about 0.3, about 0.4, about 0.5, about 0.6, about 0.7, about 0.8, about 0.8 or about 1.

In some embodiments of the process, the gel mixture may have a H₂O/SiO₂ molar ratio of less than about 14. In other embodiments, the gel mixture may have a H₂O/SiO₂ molar ratio of about 5 to about 14, about 5.5 to about 13.5, about 5.8 to about 13, about 6 to about 12, about 6.5 to about 11.5, about 7 to about 11, or about 8 to about 10. In yet another embodiment, the gel mixture may have a H₂O/SiO₂ molar ratio less than about 14, less than about 13, less than about 12, less than about 11, less than about 10, less than about 9, less than about 8, or less than about 7.

In some embodiments of the process, the zeolite crystal or the zeolite seed may be included in an amount of about 0.1 wt. % to about 8 wt. % based on total weight of the mixture. In other embodiments, the zeolite crystal or the zeolite seed may be included in an amount of about 0.1 wt. % to about 7.5 wt. %, about 0.5 wt. % to about 7 wt. %, about 1 wt. % to about 6 wt. %, about 1.5 wt. % to about 5 wt. %, about 2 wt. % to about 4 wt. % based on total weight of the mixture.

In some embodiments of the process, the gel mixture may have a solid content of at least about 15%. In certain embodiments, the gel mixture may have a solid content of about 15%, 20%, 25%, about 27%, about 30%, about 33%, about 35%, or about 37%.

In some embodiments of the process, the crystallization may be achieved by heating the gel mixture in an autoclave. In some embodiments of the process, after crystallization, the gel mixture may be separated to obtain zeolite crystals.

In some embodiments, the process includes mixing various raw materials. The raw materials may include an aluminum source, a sodium source, a silicon source, a zeolite crystal or a zeolite seed. These raw materials may be mixed in a variety of orders to achieve a desired mixing efficiency. For example, the aluminum source, and sodium source may be mixed first then the silicon source may be added. In another example, the aluminum source, sodium source and silicon source may be mixed and then the zeolite crystal or zeolite seed may be added. In yet another example, the aluminum source, sodium source, silicon source and zeolite crystal or zeolite seed may be mixed together in single step.

In some embodiments of the process, the zeolite seed may be FCC or FAU seed.

In certain embodiments, the crystallization may occur in two stages. In the first stage, a gel suspension is made by mixing an alumina source, a silica source and a base or sodium hydroxide. The gel suspension is then heated, for example, in an autoclave to crystallize for a time period. In some embodiments, the crystallization may be conducted at a temperature of about 175° C. for about 18 hours. The gel is then cooled down and discharged. After discharging, the solid crystals are separated from the liquid. The solids that are collected are zeolite crystals having a sodium form.

It was found that including a zeolite seed in the process helps promote the reaction and formation of zeolite crystals in the process of the present disclosure.

In another embodiment of the present invention, a zeolite crystal is provided. The zeolite crystal may include ZSM-5 having a SAR from about 25 to about 40 and a XRD zeolite crystallinity more than 95%. In another embodiment, the zeolite crystal may include chabazite having a SAR from about 15 to about 30 and a XRD crystallinity more than 90%.

The zeolite crystal of the present disclosure may be used in FCC catalysts or an FCC additive as is known in the art.

The zeolite crystal of the present disclosure may be used in an exhaust gas treatment system used to treat exhaust gas streams, in particular those emanating from gasoline or diesel engines as is known in the art.

A method of producing a catalytic article is also provided. The method includes coating a substrate with a catalytic coating using washcoat process. The method may further include drying and calcining the coated substrate at a temperature of about 550° C. for about 1 hour. In some embodiments, the drying and calcining may occur at a temperature of about 450° C. to about 750° C., 500° C. to about 700° C., or about 550° C. to about 650° C. In some embodiments, the drying and calcining may occur for about 1 hour to about 12 hours, about 2 hours to about 10 hours, or about 4 hours to about 8 hours.

In some embodiments, the catalytic coating may include a chabazite, about 3.0 wt % to about 6.0 wt % copper oxide, about 5 wt % zirconium oxide, and about 5 wt % pseudoboehmite binder. In some embodiments, the catalytic coating may include copper oxide in an amount of about 1 wt % to about 20 wt %, about 2 wt % to about 15 wt %, about 3 wt % to about 10 wt %, or about 4 wt % to about 8 wt %. In some embodiments, the catalytic coating may include zirconium oxide in an amount of about 1 wt % to about 15 wt %, about 2 wt % to about 12 wt %, about 3 wt % to about 10 wt %, or about 4 wt % to about 8 wt %. In some embodiments, the catalytic coating may include a pseudoboehmite binder, such as PB-250. The pseudoboehmite binder may be included in an amount of about 1 wt % to about 30 wt %, about 2 wt % to about 25 wt %, about 3 wt % to about 20 wt %, about 4 wt % to about 15 wt %, about 5 wt % to about 10 wt %, or about 6 wt % to about 8 wt %.

In some embodiments, a catalytic article may be produced by any of the methods/processes described herein. In some embodiments, the catalytic article may include an ion-exchanged chabazite, wherein the chabazite has a zeolite surface area (ZSA) of greater than about 450 m²/g. In some embodiments, the chabazite may have a ZSA of greater than about 460 m²/g, greater than about 470 m²/g, greater than about 480 m²/g, greater than about 500 m²/g, or greater than about 550 m²/g.

In another embodiment, a method of reducing nitrogen oxides is provided. The method includes contacting a gaseous stream including nitrogen oxides with at least one ion exchanged chabazite as described herein or at least one catalytic article as described herein.

### EXAMPLES

Examples of the process and materials used in some embodiments of the present disclosure are herein presented in Table 1. N-brand is commercially available sodium silicate. AS-40 is a commercial colloidal silica that contains 40 wt % SiO₂. ZSM-5 seeds use commercially available ZSM-5 materials with sodium oxide content less than 0.4 wt % and particle size D90≤21 micron.

In this study, different raw material and solid content were tested. During this study, the raw materials were mixed and crystallized according to the conditions presented in Table 1. As can be seen from Table 1, it was found that when hydrous kaolin (HK slurry) was used having a high solid content of gel mixture (above 30 wt %), it had superior properties to Comparative Example 1, which represents the current state of the art.

TABLE 1

| | Solid | Raw | Crystallization | Gel | OH—/ |
|---|---|---|---|---|---|
| Example | wt % | material | Condition | SAR | SiO₂ |
| Comparative | 17 | AS-40/N-brand, | 180° C./24 hr | 42 | 0.28 |
| Example 1 | | NaAlO₂ | | | |
| Example 1 | 35 | AS-40/N-brand, | 175° C./24 hr | 35 | 0.22 |
| | | HK slurry, | | | |
| | | ZSM-5 seeds | | | |
| Example 2 | 33 | AS-40/N-brand, | 175° C./24 hr | 35 | 0.22 |
| | | HK slurry, | | | |
| | | ZSM-5 seeds | | | |
| Example 3 | 33 | AS-40/N-brand, | 175° C./18 hr | 35 | 0.22 |
| | | HK slurry, | | | |
| | | ZSM-5 seeds | | | |

The properties of the HK slurry are presented in Table 2. HK slurry has a solid content of about 70 wt %.

TABLE 2

| | Al₂O₃ wt % | SiO₂ wt % | D50, μm | D90, μm |
|---|---|---|---|---|
| HK slurry | 44.71 | 51.39 | 1.82 | 7.89 |

The properties of as-crystallized zeolite crystals of Comparative Example 1 and Examples 1-3 were also gathered and are presented in Table 3. The high solid formulation of Examples 1-3 had similar or better crystallinity than the low solid formulation of Comparative Example 1. After the post-treatment with acid wash to remove sodium, all H-form ZSM-5 materials in Table 3 have TSA>260 m²/g.

TABLE 3

| | TSA, | MSA, | ZSA, | Na₂O, | Al₂O₃, | SiO₂, | XRD | |
|---|---|---|---|---|---|---|---|---|
| Example | m²/g | m²/g | m²/g | wt % | wt % | wt % | % | SAR |
| Comp. Ex. 1 | 272 | 31 | 241 | 3.34 | 5.31 | 91.36 | 88 | 29.3 |
| Ex. 1 | 279 | 36 | 243 | 3.46 | 5.61 | 90.74 | 88 | 27.5 |
| Ex. 2 | 262 | 45 | 217 | 3.45 | 5.40 | 91.09 | 89 | 28.7 |
| Ex. 3 | 289 | 33 | 255 | 3.86 | 5.54 | 89.75 | 90 | 27.5 |

An additional study was conducted preparing a chabazite zeolite. As understood by one of skill in the art, having a solid content of greater than 10 wt % is considered high in the synthesis of chabazite when the alumina source is from aluminum silicate crystalline material. Hydrous kaolin is the lowest cost aluminum source, while the cost of Na-FAU used in Comparative Example 2 is ~20 times higher. The present inventors have found that using a chabazite having 18 wt % solids was successful and had similar or better crystallinity than a low solid formulation. Ludox AS-40 is a commercial colloidal silica that contains 40 wt % SiO₂. Trimethyl adamantly ammonium hydroxide was used as an OSDA.

During this study, the raw materials were mixed and crystallized according to the conditions presented in Table 4. As can be seen from Table 4, it was found that when hydrous kaolin (HK slurry) was used having a high solid content of gel mixture (above 18 wt %), it had superior properties to Comparative Example 2, which represents the current state of the art.

TABLE 4

| | Solid | | Crystallization | Gel | OH—/ |
|---|---|---|---|---|---|
| Example | wt % | Raw material | Condition | SAR | SiO₂ |
| Comparative | 9.1 | Sodium Silicate/ | 140° C./108 hr | 29 | 0.505 |
| Example 2 | | Sodium | | | |
| | | sulfate/sulfuric | | | |
| | | acid/Na- | | | |
| | | FAU/OSDA | | | |
| Example 4 | 18.4 | AS-40/Sodium | 160° C./108 hr | 20 | 0.18 |
| | | sulfate/sulfuric | | | |
| | | acid/HK | | | |
| | | slurry/OSDA | | | |

The properties of as-crystallized zeolite crystals of Comparative Example 2 and Example 4 was also gathered and are presented in Table 5. The high solid formulation of Example 4 had similar or better crystallinity than the low solid formulation of Comparative Example 2. After the post-treatment with ammonium exchange to remove sodium, all H-form chabazite materials in Table 5 have TSA>530 m²/g.

TABLE 5

| | TSA, | MSA, | ZSA, | Na₂O, | Al₂O₃, | SiO₂, | XRD | |
|---|---|---|---|---|---|---|---|---|
| Example | m²/g | m²/g | m²/g | wt % | wt % | wt % | % | SAR |
| Comp. Ex. 2 | 594 | 13.8 | 579.8 | 2.37 | 9.32 | 88.31 | 95 | 16.1 |
| Ex. 4 | 561 | 15 | 545 | 1.46 | 8.06 | 90.48 | 95 | 19.1 |

While certain embodiments have been illustrated and described, it should be understood that changes and modifications can be made therein in accordance with ordinary skill in the art without departing from the technology in its broader aspects as defined in the following claims.

The embodiments, illustratively described herein, may suitably be practiced in the absence of any element or elements, limitation or limitations, not specifically disclosed herein. Thus, for example, the terms “comprising,” “including,” “containing,” etc. shall be read expansively and without limitation. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the claimed technology. Additionally, the phrase “consisting essentially of” will be understood to include those elements specifically recited and those additional elements that do not materially affect the basic and novel characteristics of the claimed technology. The phrase “consisting of” excludes any element not specified.

The present disclosure is not to be limited in terms of the particular embodiments described in this application. Many modifications and variations can be made without departing from its spirit and scope, as will be apparent to those skilled in the art. Functionally equivalent methods and compositions within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds, or compositions, which can of course vary. It is also to be understood that the terminology used herein is for the purpose of describing particular embodiments only, and is not intended to be limiting.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, particularly in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like, include the number recited and refer to ranges which can be subsequently broken down into subranges as discussed above. Finally, as will be understood by one skilled in the art, a range includes each individual member.

1. A process for preparing a zeolite comprising:
mixing an aluminum source, a sodium source, and water to form a first mixture;
after mixing, adding a silicon source to the first mixture and mixing;
adding a zeolite crystal or zeolite seed to form a gel mixture;
crystallizing the gel mixture at a temperature from about 150° C. to about 200° C. for about 12 to about 48 hours to obtain product zeolite crystals,
wherein the aluminum source is hydrous kaolin.

2. The process of claim 1, wherein the sodium source is sodium silicate.

3. The process of claim 1, wherein the silicon source comprises an aqueous colloidal silica with a solid at or above 20 wt. %

4. The process of claim 1, wherein the hydrous kaolin has a particle size with D90 (diameter of 90 percentage of particles) below 30 μm.

5. The process of claim 1, wherein the zeolite crystal is ZSM-5.

6. The process of claim 1, wherein the hydrous kaolin has a solid content of about 50 wt % to about 75 wt % solids.

7. The process of claim 1, wherein the zeolite crystal or zeolite seed has a silica to alumina ratio (SAR) of about 20 to about 35.

8. The process of claim 1, further comprising post-treating the product zeolite crystals with an acid wash or ion exchange to remove sodium.

9. (canceled)

10. (canceled)

11. (canceled)

12. The process of claim 1, wherein the product zeolite crystals have a XRD crystallinity of greater than about 85% and TSA greater than about 260 m²/g.

13. The process of claim 1, wherein the gel mixture has a SiO₂/Al₂O₃ molar ratio of about 30 to about 42.

14. The process of claim 1 any of the preceding claims, wherein the gel mixture has a Na₂O/SiO₂ and OH—/Si molar ratio of about 0.1 to about 0.3.

15. The process of claim 1 any of the preceding claims, wherein the gel mixture has a H₂O/SiO₂ molar ratio of less than about 11.

16. (canceled)

17. The process of claim 1, wherein the gel mixture has a solid content of at least about 25%.

18. (canceled)

19. The process of claim 1, wherein the gel mixture after crystallization is separated to obtain the product zeolite crystals.

20. The process of claim 1, wherein the zeolite crystal or the zeolite seed has a particle size with D90 below 25 μm.

21. (canceled)

22. A zeolite crystal comprising ZSM-5 having a SAR from about 24 to about 40 and a sodium content of less than about 0.4%.

23. A process for preparing a chabazite (CHA) zeolite:
preparing an aqueous mixture comprising a silica source, a sole alumina source, a base agent, and an organic structure directing agent (OSDA) to form an gel mixture;
crystallizing the gel mixture at a temperature from about 100° C. to about 200° C. for about 10 to about 108 hours to obtain zeolite crystals,
wherein the sole aluminum source is hydrous kaolin.

24. (canceled)

25. (canceled)

26. (canceled)

27. (canceled)

28. (canceled)

29. (canceled)

30. (canceled)

31. (canceled)

32. (canceled)

33. (canceled)

34. (canceled)

35. (canceled)

36. (canceled)

37. (canceled)

38. (canceled)

39. (canceled)

40. (canceled)

41. (canceled)

42. (canceled)

43. (canceled)

44. (canceled)

45. (canceled)

46. (canceled)

47. (canceled)

48. A method of producing a catalytic article comprising:
coating a substrate with a catalytic coating using a washcoat process; and
drying and calcining the coated substrate at a temperature of about 550° C. for about 1 hour;
wherein the catalytic coating comprises a chabazite, about 3.0 wt % to about 6.0 wt % copper oxide, about 5 wt % zirconium oxide, and about 5 wt % pseudoboehmite (PB-250) binder.

49. A catalytic article produced according to the method of claim 48, comprising an ion-exchanged chabazite, wherein the chabazite has a zeolite surface area (ZSA) of greater than about 450 m²/g

50. A method of reducing nitrogen oxides (NO_{X}) comprising contacting a gaseous stream comprising nitrogen oxides with at least one catalytic article of claim 49.
